(19) United States
(12) Patent Application Publication
(10) Pub. No.: US 2009/0082046 A1
(43) Pub. Date: Mar. 26, 2009

(54) Radiocommunication equipment

(76) Inventor: Teppei SHOJI, Tokyo (JP)

Correspondence Address: WENDEROTH, LIND & PONACK, L.L.P., 2033 K STREET N. W., SUITE 800, WASHINGTON, DC, 20006-1021, US

(21) Appl. No.: 12/230,783

(22) Filed: Sep. 4, 2008

(30) Foreign Application Priority Data
Sep. 25, 2007 (JP) 2007-246402

(51) Int. Cl. H04W 72/04

(52) U.S. Cl. 455/509

(57) ABSTRACT

In radiocommunication equipment that allocates communication resource regions to be used for communication with equipment of a communicating party, the number of communication resource regions to be allocated to the communicating party is satisfactorily ensured for each communicating party. An inherent information acquisition unit acquires information inherent to each piece of equipment of a communicating party. A number-of-resources information acquisition unit acquires information that specifies the number of communication resource regions to be reserved for communication with equipment of a communicating party. An association memory unit stores the association of the inherent information with the information specifying the number of communication resource regions to be reserved. For communication with equipment of a communicating party whose association is stored, a scheduling unit reserves the number of communication resource regions associated with the equipment of the communicating party, and allocates communication resource regions to be used for communication with the equipment of the communicating party.

### BACKGROUND OF THE INVENTION

1. Field of the Invention

The present invention relates to radiocommunication equipment that communicates with a communicating party by radio, or more particular, to radiocommunication equipment that satisfactorily ensures the number of communication resource regions, which is allocated to a communicating party, for each communicating party.

2. Description of the Related Art

A radiocommunication system in which, for example, an orthogonal frequency division multiplexing (OFDM) method is used to perform radiocommunication between wireless base station equipment (base transceiver station (BTS)) and terminal equipment has been implemented.

Over a downlink from the wireless base station equipment to the terminal equipment, if the OFDM access (OFDMA) technique is employed, the wireless base station equipment allocates transmitted data to a frequency range defined on a frequency axis, in which satisfactory radiocommunication quality is attained, so as to improve a throughput. Moreover, even over an uplink from the terminal equipment to the wireless base station equipment, the similar allocation can be performed.

FIG. 6 to FIG. 10 show the specifications stipulated by the Third Generation Partnership Project (3GPP) in efforts to pave the way for the radiocommunication standard of Long-term Evolution (LTE) (refer to non-patent documents 1, 2, and 3, that is, “3GPPTS” (36.300, V1.0.0, 2007-03), “3GPPTS” (36.211, V1.0.0, 2007-03), and “3GPP TS” (36.211, V1.1.0, 2007-05)).

FIG. 6 shows an example of a configuration for handling a baseband of signals to be transmitted on physical channels over a downlink.

For processing the baseband over the downlink, encoded data items having undergone channel coding, resource management (RM), or interleaving are handled as code words, and multiplied by scrambling codes by scramblers 101 and 102.

Thereafter, modulation mappers 103 and 104 perform modulation, for example, quadrature phase shift keying (QPSK), quadrature amplitude modulation (16 QAM), or 64 QAM.

Thereafter, a layer mapper 105 maps the modulated data items into layers according to a transmission rank and the number of cord words.

Thereafter, a pre-coder 106 applies a transmission *diversity to layer signals, and outputs signals in association with antennas.

Thereafter, OFDM mappers 107 and 108 map physical resource signals, which represent physical channels or physical signals and have undergone the transmission diversity, into OFDM resource elements.

OFDM signal generators 109 and 110 produce OFDM signals and transmit them to antenna ports.

FIG. 7 shows an example of a resource grid for a downlink according to the OFDM method. This example of the resource grid for a downlink is constructed for each antenna.

For one downlink slot, N^{DL}_{symb} OFDM symbols are defined in a time direction (axis of abscissas in FIG. 7), and N^{DL}_{BW} subcarriers are defined in a frequency direction (axis of ordinates in FIG. 7). A region specified with one OFDM symbol and one subcarrier (one grid) is defined as a resource element.

Moreover, a region specified with a set of (N^{DL}_{symb}×N^{RB}_{BW}) resource elements calculated by multiplying N^{DL} resource elements defined successively in an OFDM symbol direction (time direction) (resource elements equivalent to one slot) by N^{RB}_{BW} resource elements defined successively in a subcarrier direction (frequency direction) (resource elements equivalent to 180 kHz) is defined as a resource block (RB).

Resource grids assigned to multiple downlink slots and having the same construction as that shown in FIG. 7 are successively arrayed and communicated.

In this case, as for each of resource blocks or resource elements assigned to a downlink slot, the same resource block or resource element appears in cycles of the download slot.

FIG. 8 shows an example of values of parameters for an OFDM resource block to be sent over a downlink.

Specifically, as configuration parameters, a normal cyclic prefix and an extended cyclic prefix are listed. As a frame structure parameter, a generic frame structure and an alternative frame structure are listed.

FIG. 9 and FIG. 10 show examples of control extended by a media access control (MAC) scheduler for a downlink shares channel (DL-SCH). FIG. 9 shows a node B equivalent to wireless base station equipment, and FIG. 10 shows user equipment (UE) such as terminal equipment.

FIG. 9 shows the link between the MAC scheduler and a baseband processing unit like the one shown in FIG. 6.

The MAC scheduler uses channel-state information, a power value, and the number of resource blocks to control the number of resource blocks in the baseband processing unit, a modulation method, OFDM mapping, or antenna mapping.

As for scheduling to be performed by the foregoing MAC scheduler, there is room for further development, and further improvement is long requested. In particular, implementation of scheduling capable of allocating a sufficient number of communication resource regions (for example, resource blocks) to each piece of terminal equipment (user equipment) has been desired.

Patent document 1: JP-A-2004-128967

Non-Patent document 1: 3GPP TS 36.300 V1.0.0 (2007-03)

Non-Patent document 2: 3GPP TS 36.211 V1.0.0 (2007-03)

Non-Patent document 3: 3GPP TS 36.211 V1.1.0 (2007-05)

### SUMMARY OF THE INVENTION

The present invention attempts to break through the foregoing situation. An object of the present invention is to provide radiocommunication equipment capable of satisfactorily ensuring the number of communication resource regions, which is allocated to a communicating party, for each communicating party.

In order to accomplish the above object, according to the present invention, radiocommunication equipment that allocates communication resource regions to be used for communication with equipment of a communicating party has a configuration described below.

Specifically, an inherent information acquisition means acquires information inherent to each piece of equipment of a communicating party. A number-of-resources information acquisition means acquires information specifying the number of communication resource regions to be reserved for communication with the equipment of the communicating party. An association memory means stores information which is inherent to each piece of equipment of a communicating party and is acquired by the inherent information acquisition means, and information, which specifies the number of communication resource regions to be reserved for communication with the equipment of the communicating party and is acquired by the number-of-resources information acquisition means, in association with each other. For communication with equipment of a communicating party whose association is found to be stored on the basis of the contents of storage in the association memory means, a scheduling means reserves the specified number of communication resource regions associated with the equipment of the communicating party, and allocates communication resource regions which are used for communication with the equipment of the communicating party.

Consequently, the number of communication resource regions reserved (booked) in advance is managed in relation to each communicating party. When communication resource regions are allocated (scheduled), the managed number of communication resource regions are ensured. Thus, the number of communication resource regions to be allocated to a communicating party can be satisfactorily ensured for each communicating party.

The radiocommunication equipment may be adapted to any type of equipment, for example, communication equipment included in any of various types of radiocommunication systems, such as, wireless base station equipment or terminal equipment and communication equipment for broadcast.

Moreover, the radiocommunication equipment is, as the most preferable form, equipment that communicates data according to the OFDM method.

Moreover, as the equipment of a communicating party, any type of equipment may be adopted. As for the number of pieces of equipment of communication parties, multiple pieces of equipment are conceivable. However, only one equipment or no equipment may be involved depending on a communicating situation.

Moreover, information inherent to each piece of equipment of a communicating party may be any information. For example, a number or a symbol with which equipment is identified may be adopted.

Moreover, a technique for acquiring information inherent to each piece of equipment of a communicating party may be any method. For example, a form in which information inherent to equipment of a communicating party may be read from a card having the information stored in a memory thereof is conceivable.

Information specifying the number of communication resource regions to be reserved for communication with equipment of a communicating party may be any information. For example, information representing a value that indicates the number of communication resource regions may be adopted.

Moreover, a technique for acquiring information that specifies the number of communication resource regions to be reserved for communication with equipment of a communicating party may be any technique. For example, a technique of acquiring new information or the contents of modification, which is performed on registered information, from a personal computer or the like may be adopted.

Moreover, the association memory means may be realized with, for example, a memory.

Moreover, for communication with equipment of a communicating party whose association (the number of communication resource regions to be reserved) is not stored in the association memory means, the scheduling means allocates available communication resource regions that are unused and are not reserved (booked) for equipment of any other communicating party.

Moreover, the communication resource region may be any region, for example, a region to be segmented in a frequency direction, or a region to be segmented in the frequency direction and a time direction. This kind of communication resource region may be adopted as a unit of allocation.

Moreover, as for the segments in the frequency direction, for example, part or the whole of multiple subcarriers defined according to the OFDM method or the like may be employed.

Moreover, as for the segments in the time direction, part or the whole of multiple symbols defined according to the OFDM method or the like may be employed. Incidentally, the number of symbols is, for example, the number of symbols to be transmitted for one slot.

Moreover, the communication resource region may be a region of a resource block defined according to the OFDM method or a region of a predetermined number of resource elements that is one or more resource elements.

For example, when the communication resource region cannot be segmented in the time direction, the communication resource region may be segmented in the frequency direction alone. Otherwise, the communication resource region may be segmented in the frequency direction and time direction alike.

Moreover, the number of communication resource regions to be allocated to equipment of a communicating party may be any number of communication resource regions. For example, one or more communication resource regions are allocated. However, the number of communication resource regions may be null under a certain communicating situation. Moreover, the number of communication resource regions to be allocated to the equipment of the communicating party may be controlled to be variable depending on, for example, the communicating situation.

Moreover, as the technique for scheduling (allocating communication resource regions), any technique may be adopted.

Moreover, when multiple pieces of equipment of communicating parties exist, scheduling (allocation of communication resource regions) is performed based on pieces of information on communication quality received from the multiple pieces of equipment of the communicating parties in consideration of the multiple pieces of equipment of the communicating parties. In general, communication resource regions are allocated to the equipment of the communicating party relative to which communication quality is satisfactory. Thus, preferably, scheduling should be performed to guarantee satisfactory communication quality.

Moreover, as the information on communication quality, any information may be adopted. For example, as information on received power carried by a pilot signal, information on a channel quality indicator (CQI) of the pilot signal may be adopted. In general, the amplitude and phase of the pilot signal are set to standard values and ascertained by both a transmitting side and a receiving side.

As described so far, according to radiocommunication equipment in which the present invention is implemented, the number of communication resource regions reserved (booked) in advance is managed in relation to each communicating party. When communication resource regions are allocated (scheduled), the managed number of communication resource regions is ensured. Consequently, the number of communication resource regions to be allocated to a communicating party can be satisfactorily ensured for each communicating party.

### BRIEF DESCRIPTION OF THE DRAWINGS

FIG. 1 shows an example of a configuration of wireless base station equipment in accordance with an embodiment of the present invention for a downlink;

FIG. 2 shows an example of a resource block booking table;

FIG. 3 shows an example of a procedure of resource block registration/deletion processing to be performed when a universal subscriber identity module (USIM) card is connected;

FIG. 4 shows an example of a procedure of number-of-resource blocks change/initialization processing to be performed when a personal computer is connected;

FIG. 5 shows an example of a procedure of MAC scheduling;

FIG. 6 shows an example of a configuration for handling a baseband to be transmitted over a downlink;

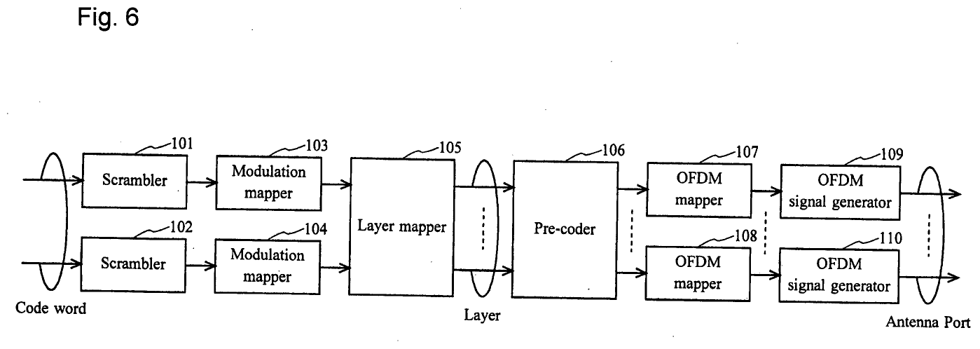

FIG. 7 shows an example of a resource grid defined for a downlink according to the OFDM method;

FIG. 8 shows an example of resource block parameters defined for a downlink according to the OFDM method;

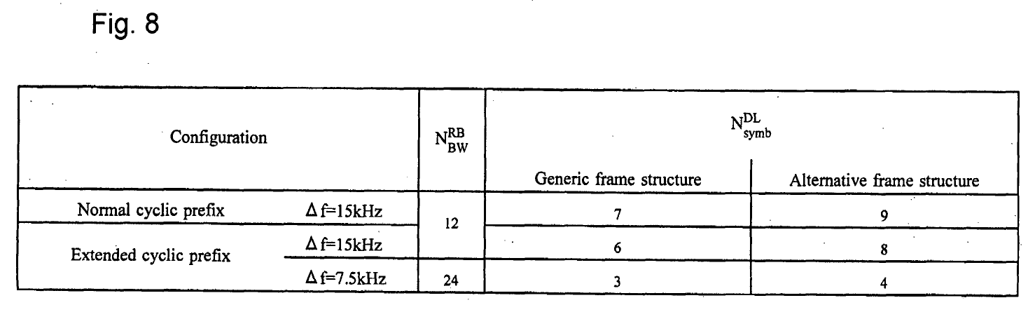

FIG. 9 shows an example of control extended by an MAC scheduler for a downlink shared channel (DL-SCH); and

FIG. 10 shows an example of control extended by the MAC scheduler for the DL-SCH.

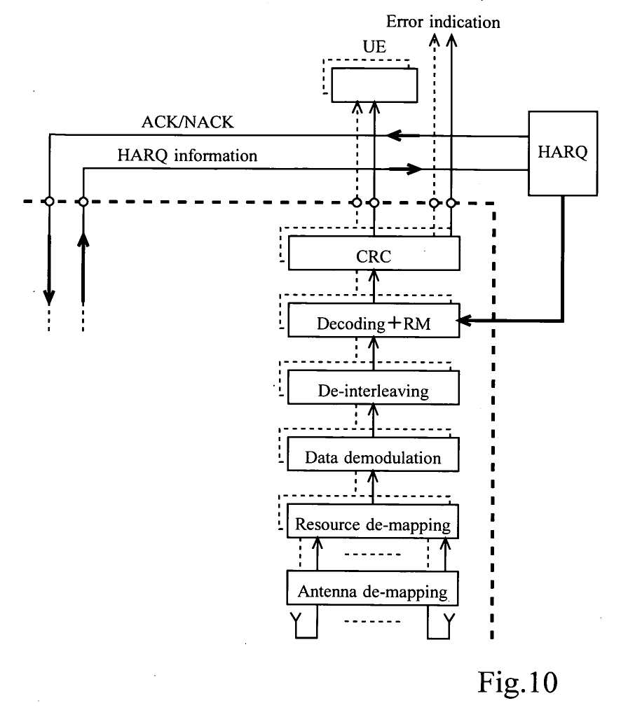

### DESCRIPTION OF THE PREFERRED EMBODIMENT

Referring to the drawings, an embodiment of the present invention will be described below.

To begin with, scheduling and radiocommunication quality (channel quality indicator (CQI)) will be outlined below.

Wireless base station equipment (base transceiver station (BTS)) performs radiocommunication with multiple pieces of portable terminal equipment (users) according to the OFDM method.

Scheduling to be performed by the wireless base station equipment is to allocate a resource block, which is used for radiocommunication on a channel, to each channel assigned to each piece of terminal equipment.

In this example, resource blocks are allocated to a common control channel or data channels. The terminal equipment detects radiocommunication quality (CQI) according to the communicated state of a pilot signal. Based on the result of the detection, the wireless base station equipment performs scheduling for the data channels or the like.

For example, on the common control channel, the pilot signal is allocated to all OFDM symbols and all subcarriers. As for the data channels, a data signal is fundamentally allocated to the data channels. The pilot signal is also allocated to part of the positions of OFDM symbols and subcarriers.

Moreover, as a concrete technique for scheduling, any technique may be adopted. For example, scheduling is performed in a form in which radiocommunications among wireless base station equipment and multiple pieces of terminal equipment are performed successfully. According to one technique, assuming that the radiocommunication quality (CQI) of a certain resource block to certain terminal equipment is satisfactory, the resource block is continuously used as it is. If the radiocommunication quality (CQI) of a certain resource block to certain terminal equipment is degraded, the resource block is reserved and allocated to any other terminal equipment. Any other resource block relative to which radiocommunication quality (CQI) becomes satisfactory is allocated to the certain terminal equipment.

Some examples of allocation (scheduling) of a resource block have been presented. Any other form may be adopted.

For example, instead of the form in which one resource block is allocated to one channel assigned to one terminal equipment, a form in which one resource block is allocated to multiple pieces of terminal equipment (multiple channels), and a form in which one resource element or an arbitrary number of resource elements is allocated as a unit may be adopted.

Moreover, scheduling is performed on data to be transmitted from the wireless base station equipment to the terminal equipment. The same scheduling may be performed on data to be transmitted from the terminal equipment to the wireless base station equipment.

In the present embodiment, a control quality indicator (CQI) is adopted as information representing radiocommunication quality. The CQI represents a value of power of a received signal. The larger the CQI is, the higher the radiocommunication quality is.

For example, when allocation is performed in units of a resource block, the value of the power of a pilot signal contained in one resource block is detected as the CQI. When multiple pilot signals are contained in one resource block, a mean value of the powers of the pilot signals may be adopted as the CQI.

The CQI is, for example, a discrete digital value, and takes on a value ranging from 1 to 30. In this case, 1 is a lower limit, and 30 is an upper limit. The definition of the CQI may be determined arbitrarily for each system.

In the present embodiment, the data signal is not used to detect the CQI. If a received data signal contains an error, a receiving side issues a retransmission request to a transmitting side, or requests the transmitting side to raise the power of a signal to be transmitted.

In scheduling to be performed by the wireless base station equipment, regions (for example, resource blocks) that are employed in radiocommunication to each piece of terminal equipment are allocated in consideration of the CQIs of multiple regions (for example, resource blocks) reported from multiple pieces of terminal equipment. In general, over a certain frequency range, the communication characteristic of one terminal equipment (for example, the frequency characteristic) and the communication characteristic of another terminal equipment (for example, the frequency characteristic) are different from each other. The frequency range should be allocated to the terminal equipment that exhibits a satisfactory characteristic over the frequency range.

Next, wireless base station equipment conformable to the Long-term Evolution (LTE) standard in accordance with the present embodiment will be described below.

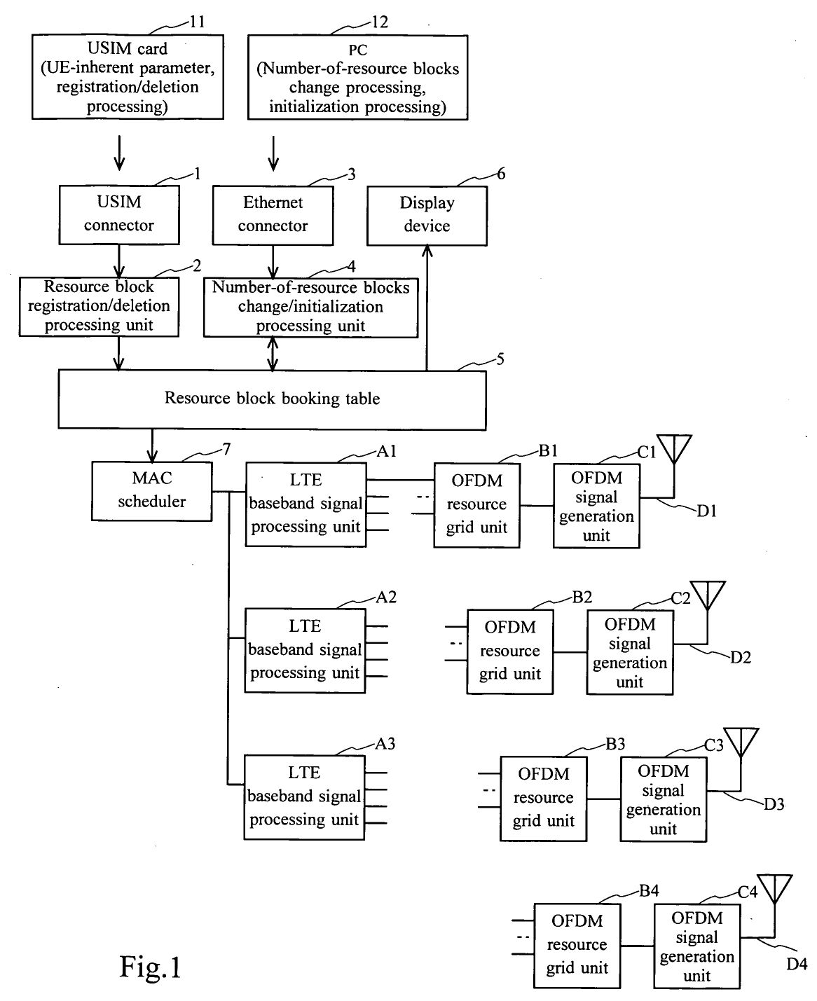

FIG. 1 shows an example of a configuration of wireless base station equipment in accordance with the present embodiment for a downlink. A universal subscriber identity module (USIM) card 11 and a personal computer (PC) 12 are also shown.

In the present embodiment, the wireless base station equipment includes four transmission antennas.

The wireless base station equipment of the present embodiment includes a USIM connector 1, a resource block registration/deletion processing unit 2, an Ethernet connector 3, a resource block change/initiation processing unit 4, a resource block booking table 5, a display device 6, a media access control (MAC) scheduler 7, multiple LTE baseband signal processing units A1, A2, and A3, four OFDM resource grid units B1 to B4, four OFDM signal generation units C1 to C4, and four antennas D1 to D4.

The USIM card 11 includes, for example, a memory. Data of a parameter inherent to each piece of terminal equipment (user equipment (UE)) (UE-inherent parameter) is stored in the memory. The USIM card 11 is used to register or delete the UE-inherent parameter in or from the wireless base station equipment.

The personal computer 12 has the capability for performing the processing of changing the number of resource blocks, which is registered in the wireless base station equipment, from one to another, or initializing the number of resource blocks. The personal computer 12 is manipulated by, for example, a human being.

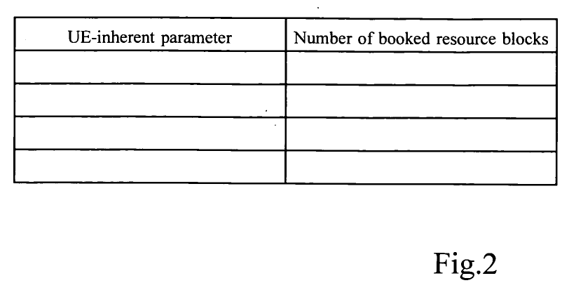

FIG. 2 shows an example of the structure of the resource block booking table 5.

In the resource block booking table 5 of the present embodiment, a parameter inherent to each piece of terminal equipment (US) (UE-inherent parameter) and the number of booked resource blocks are recorded in association with each other.

The resource block booking table 5 is used to manage the situation of booking resource blocks for each piece of terminal equipment (UE), and is a table in which a UE-inherent parameter acquired from the USIM card 11 is recorded. The resource block booking table 5 includes two elements of the UE-inherent parameter and the number of booked resource blocks.

Incidentally, the UE-inherent parameter is acquired from the USIM card 11 inserted to the terminal equipment for which resource blocks should be reserved.

Moreover, the number of booked resource blocks refers to the number of resource blocks to be reserved and may be changed to another by the personal computer 12.

The display device 6 is realized with, for example, a liquid crystal display (LCD) that displays various kinds of information, or light emitting diodes (LEDs) that are lit to indicate various states. In the present embodiment, information on the result of the resource block registration/deletion processing or the result of the resource block change/initiation processing is displayed.

The display device 6 is included, for example, separately from the personal computer 12. Alternatively, a display device included in the personal computer 12 may be utilized as the display device 6.

An example of an operation to be performed by the wireless base station equipment of the present embodiment will be described below.

The USIM connector 1 includes a connector part to which the USIM card 11 is inserted. The USIM card 11 may be, for example, manually inserted into the connector part by a human being or pulled out of the connector part.

With the USIM card 11 inserted into the USIM connector 1, the UE-inherent parameter stored in the memory of the USIM card 11 is acquired.

The resource block registration/deletion processing unit 2 performs the processing of registering in the resource block booking table 5 the information on the UE-inherent parameter acquired from the USIM card 11 inserted to the USIM connector 1, or the processing of deleting information recorded in the resource block booking table 5.

In the present embodiment, when the USIM card 11 is inserted, registration processing and deletion processing are switched according to the presence or absence of the UE-inherent parameter in the resource block booking table 5.

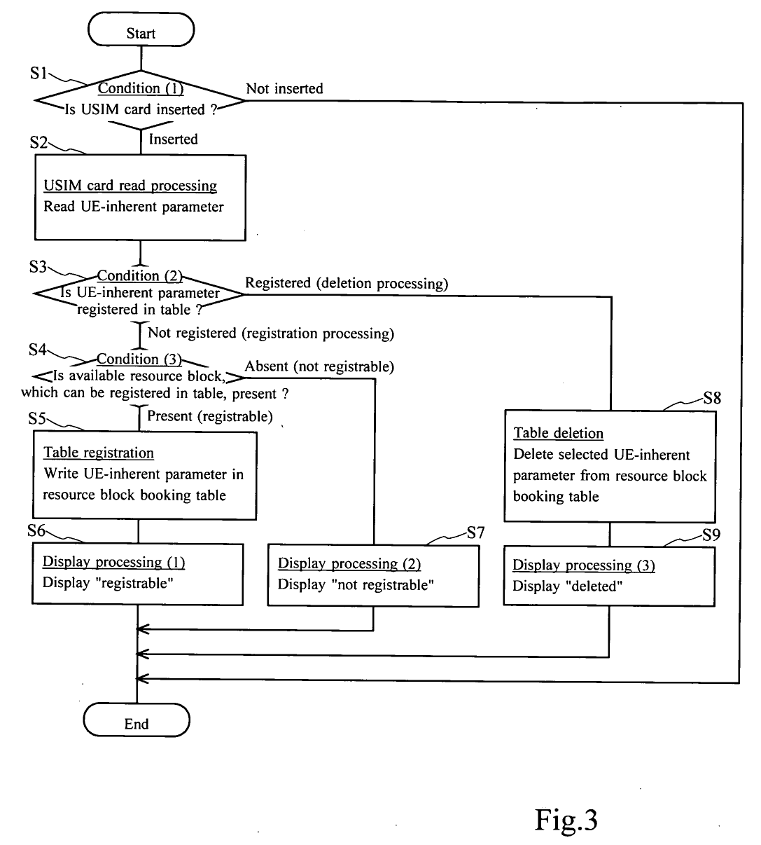

Referring to FIG. 3, an example of a procedure of resource block registration/deletion processing to be performed by the resource block registration/deletion processing unit 2 included in the present embodiment when the USIM card is connected (steps S1 to S9) will be described below.

Whether the USIM card 11 is inserted to the USIM connector 1 (inserted or not inserted) is verified as a condition (1) (step S1). If the USIM card is not inserted, the processing is terminated.

On the other hand, if the USIM card 11 is inserted, the processing of reading the UE-inherent parameter from the USIM card 11 (read processing) is performed (step S2).

Whether the UE-inherent parameter read from the USIM card 11 is registered in the resource block booking table 5 (registered or unregistered) is verified as a condition (2) (step S3). If the UE-inherent parameter is not registered (unregistered), registration processing is performed. If the UE-inherent parameter is registered (registered), deletion processing is performed.

If it is found at step S3 that the UE-inherent parameter read from the USIM card 11 is not registered in the resource block booking table 5, whether an available resource block that can be registered this time in the resource block booking table 5 is present is verified as a condition (3) (step S4).

If an available resource block capable of being registered is present, registration can be performed (registrable). The UE-inherent parameter read from the USIM card 11 is written and registered in the resource block booking table 5 (step S5). The display device 6 then performs as display processing (1) display of signifying that registration is completed (registrable) (step S6).

On the other hand, if an available resource block capable of being registered is absent, registration cannot be performed (not registrable). Registration processing is regarded as being abnormally terminated, and the display device 6 performs as display processing (2) display of signifying that registration processing is abnormally terminated (not registrable) (step S7).

If it is found at step S3 that the UE-inherent parameter read from the USIM card 11 is registered in the resource block booking table 5, information on the UE-inherent parameter read from the USIM card 11 is deleted from the resource block booking table 5 (step S8). The display device 6 performs as display processing (3) display of signifying that deletion is completed (deleted) (step S9).

The Ethernet connector 3 includes a connector part into which a line over which the wireless base station equipment is connected to the personal computer 12 so that they can communicate each other (for example, a connection cable) is plugged. For example, the connection cable can manually be plugged into the connector part by a human being or unplugged out of the connector part.

In a state in which the connection cable is plugged into the Ethernet connector 3 and the wireless base station equipment is connected to the personal computer 12 so that they can communicate each other, number-of-resource blocks change/initiation processing can be performed.

With the wireless base station equipment connected to the personal computer 12 via the Ethernet connector 3 so that they can communicate with each other, the number-of-resource blocks change/initiation processing unit 4 performs the processing of changing the number of booked resource blocks in the resource block booking table 5 or the processing of initializing information registered in the resource block booking table 5 in response to an instruction sent from the personal computer 12.

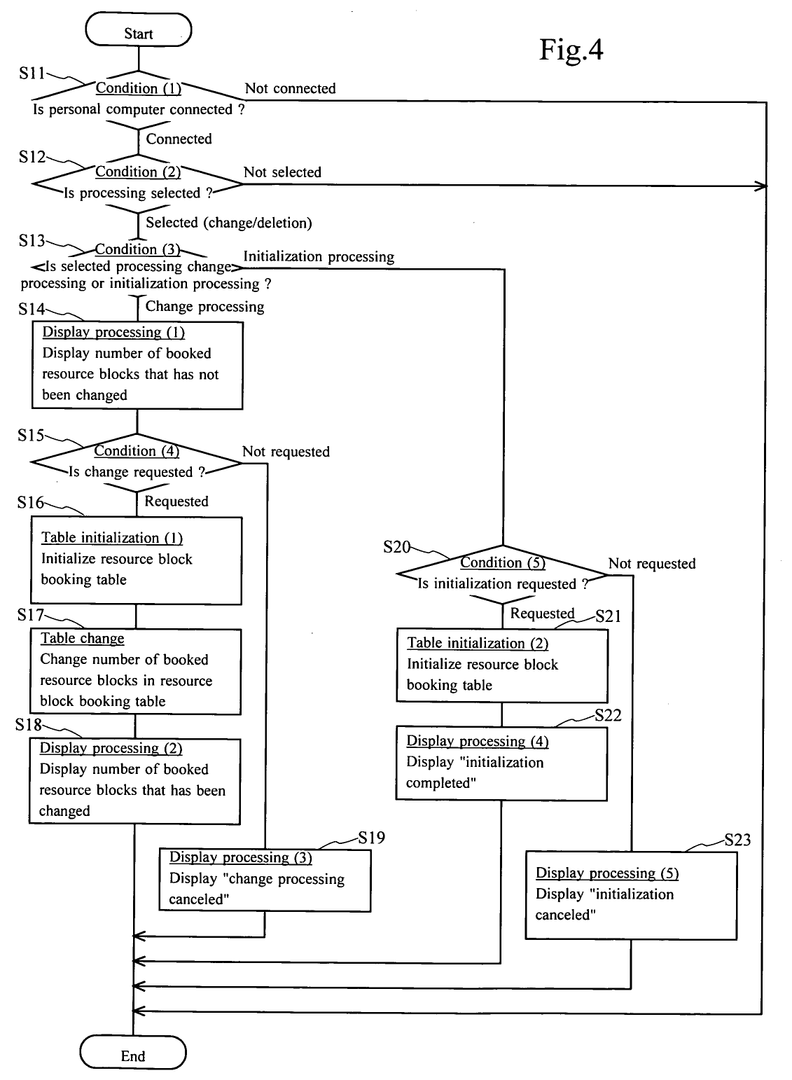

Referring to FIG. 4, an example of a procedure of number-of-resource blocks change/initialization processing to be performed by the number-of-resource blocks change/initialization processing unit 4 included in the present embodiment when the PC is connected (steps S11 to S23) will be described below.

Whether the personal computer 12 is connected to the Ethernet connector 3 (PC connected or not connected) is verified as a condition (1) (step S11). If the personal computer 12 is not connected, the processing is terminated.

On the other hand, if the personal computer 12 is connected to the Ethernet connector 3, whether effective processing is selected by the personal computer 12 via the Ethernet connector 3 (processing selected or unselected) is verified as a condition (2) (step S12). If effective processing is not selected, the processing is terminated.

If it is found at step S12 that change/initialization processing is selected as effective processing by the personal computer 12, whether the contents of the selected processing refer to change processing or initialization processing is decided as a condition (3) (step S13).

If the contents of the selected processing refer to change processing (step S13), the display device 6 (or the display device of the personal computer 12) performs as display processing (1) display of indicating the number of booked resource blocks, which has not yet been changed, so that the number of booked resource blocks having not yet been changed can be confirmed (step S14).

Next, whether a request for changing the number of booked resource blocks is issued from the personal computer 12 (change requested or not requested) is verified as a condition (4) (step S15). If the request is issued, all pieces of information registered in the resource block booking table 5 are cleared as table initialization (1) prior to change (step S16) The number of booked resource blocks in the resource block booking table 5 is changed in response to the request for change (step S17). The display device 6 (or the display device of the personal computer 12) performs as display processing (2) display of indicating the number of booked resource block that has been changed (step S18).

On the other hand, if the request for change is not issued, the display device 6 (or the display device of the personal computer 12) performs as display processing (3) display of signifying that change processing is canceled (change canceled) (step S19).

If it is found at step S13 that the contents of the selected processing refer to initialization processing, whether the request for initialization of the resource block booking table 5 is issued (initialization requested or not requested) is verified as a condition (5) (step S20). If the request for initialization is issued, all pieces of information registered in the resource block booking table 5 are cleared or initialized as table initialization (2) (step S21). The display device 6 (or the display device of the personal computer 12) performs as display processing (4) display of signifying that initialization is completed (initialization completed) (step S22).

On the other hand, if the request for initialization is not issued, the display device 6 (or the display device of the personal computer 12) performs as display processing (5) display of signifying that initialization processing is canceled (initialization canceled) (step S23).

The MAC scheduler 7 references information (parameter) registered in the resource block booking table 5 and uses the information to perform scheduling (resource block allocating operation).

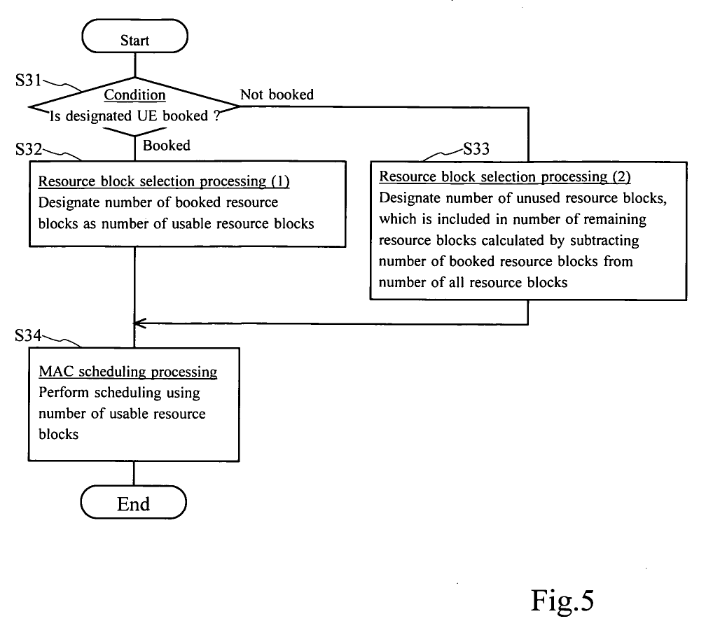

Referring to FIG. 5, an example of a procedure of MAC scheduling processing (steps S31 to S34) to be performed by the MAC scheduler 7 included in the present embodiment will be described below.

To begin with, for deciding whether a condition is met, the MAC scheduler 7 verifies whether the UE-inherent parameter read from the USIM card 11 of terminal equipment (UE), which is involved in scheduling, is registered in the resource block booking table 5 (designated UE booked or not booked) (step S31)

If the UE-inherent parameter of the terminal equipment involved in scheduling is registered in the resource block booking table 5, the MAC scheduler 7 designates the number of booked resource blocks, which is registered in the resource block booking table 5, as the number of resource blocks usable at the time of allocating resource blocks to the terminal equipment (number of usable resource blocks) (step S32).

On the other hand, if the UE-inherent parameter of the terminal equipment involved in scheduling is not registered in the resource block booking table 5, the MAC scheduler 7 performs resource block selection processing (2), that is, the MAC scheduler 7 designates the number of unused resource blocks, which is included in the number of resource blocks (number of remaining resource blocks) calculated by subtracting the total of booked resource blocks registered in the resource block booking table 5 from the number of all resource blocks (number of usable resource blocks), as the number of resource blocks usable for resource block allocation (number of usable resource blocks) (step S33).

After the aforesaid resource block selection processing (1) or (2) is completed, the MAC scheduler 7 uses the designated number of usable resource blocks to perform scheduling for the terminal equipment involved in scheduling, and allocates the number of resource blocks (step S34).

To be more specific, when terminal equipment is registered in the resource block booking table 5 (registered UE), the MAC scheduler 7 can use the number of resource blocks booked in advance to allocate resource blocks to the terminal equipment involved in scheduling. Consequently, a throughput of the number of booked resource blocks (booked resource blocks) can be guaranteed.

On the other hand, when terminal equipment is not registered in the resource block booking table 5 (unregistered UE), the MAC scheduler 7 uses the number of resource blocks (number of unused resource blocks), which is calculated by subtracting the sum total of booked resource blocks registered in the resource block booking table 5 from the number of all resource blocks, to allocate resource blocks.

The MAC scheduler 7 outputs the result of scheduling to the LTE baseband signal processing units A1, A2, and A3 so as to thus notify the processing units of the result of scheduling.

Based on the result of scheduling notified by the MAC scheduler 7, each of the LTE baseband signal processing units A1, A2, and A3 processes a baseband signal.

The OFDM resource grid units B1 to B4 are associated with the antennas D1 to D4. Based on the results of baseband signal processing performed by the LTE baseband signal processing units A1, A2, and A3, the OFDM resource grid units map data, which is an object of transmission, to OFDM resource grids.

The OFDM signal generation units C1 to C4 are associated with the antennas D1 to D4, and generate OFDM signals on the basis of inputs received from the OFDM resource grid units B1 to B4.

The antennas D1 to D4 transmit the OFDM signals, which are generated by the OFDM signal generation units C1 to C4, by radio.

As mentioned above, in the wireless base station equipment (BTS) of the present embodiment conformable to the LTE standard, when resource blocks (RB) are allocated for downlink communication, data inherent to portable terminal equipment (UE) (UE-inherent parameter) is acquired from the USIM card 11 inserted into the USIM connector 1. The resource block registration/deletion processing unit 2 performs the processing of registering the UE-inherent parameter, which is acquired from the USIM card 11, in the resource block booking table 5, or the processing of deleting the contents of registration from the resource block booking table 5. The personal computer 12 connected to the Ethernet connector 3 can be used to initiate number-of-booked resource blocks change/initialization processing. The number-of-resource blocks change/initialization processing unit 4 performs the processing of changing the number of booked resource blocks in the resource block booking table 5 or the processing of initializing the resource block booking table 5. The UE-inherent parameter acquired from the USIM card 11 is recorded in the resource block booking table 5 in order to manage the resource block booking situation in relation to each piece of terminal equipment. The display device 6 displays the result of resource block registration/deletion processing or the result of number-of-resource blocks change/initialization processing. The MAC scheduler 7 performs scheduling using the parameters in the resource block booking table 5.

Consequently, in the wireless base station equipment of the present embodiment, the UE-inherent parameter is registered in advance in the resource block booking table 5 in order to manage the number of booked resource blocks in relation to each piece of terminal equipment. When the MAC scheduler 7 allocates (schedules) resource blocks, the number of resource blocks to be allocated to each piece of terminal equipment can be guaranteed within the number of booked resource blocks. Consequently, the downlink throughput of the terminal equipment registered in the resource block booking table 5 can be guaranteed within the number of booked resource blocks.

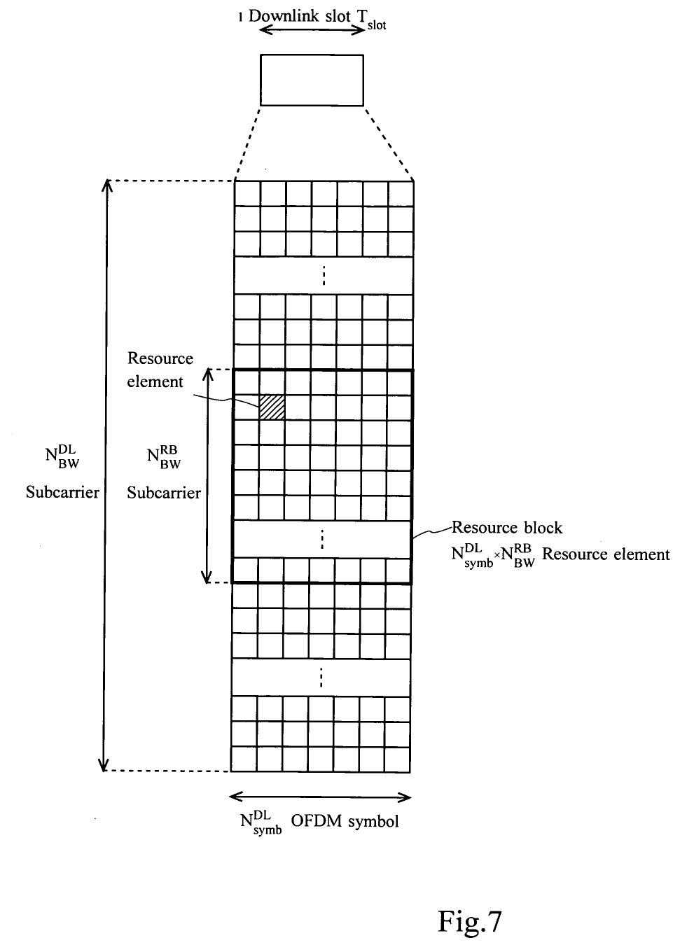

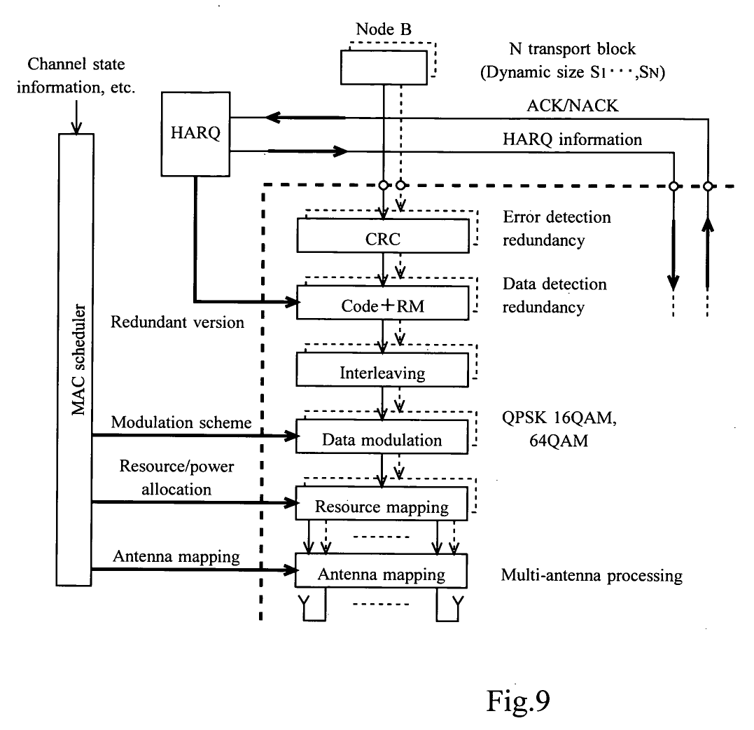

The technology of the present embodiment can be applied to a system in which the MAC scheduler like the one shown in FIG. 9 performs resource block allocation (scheduling) using the downlink resource grid like the one shown in FIG. 7.

In the wireless base station equipment of the present embodiment (an example of radiocommunication equipment), an inherent information acquisition means is realized with the capability of the resource block registration/deletion processing unit 2 for acquiring (reading) information (UE-inherent parameter in the present embodiment) inherent to terminal equipment (example of equipment of a communicating party) from the USIM card 11 inserted into the USIM connector 1. A number-of-resources information acquisition means is realized with the capability of the number-of-resource blocks change/initialization processing unit 4 for acquiring (reading) information, which specifies the number of communication resource regions (resource blocks in the present embodiment) to be reserved (booked) for communication (data transmission) with the terminal equipment, from the personal computer 12 connected to the Ethernet connector 3. An association memory means is realized with the resource block booking table 5 making it possible to store in a memory information inherent to each piece of terminal equipment (UE-inherent parameter in the present embodiment) and the number of communication resource regions (the number of booked resource blocks in the present invention) in association with each other. A scheduling means is realized with the capability of the MAC scheduler 7 for performing scheduling (resource block allocation processing in the present embodiment) on the basis of the contents of storage in the resource block booking table 5.

The configurations of a system or equipment relevant to the present invention are not limited to the aforesaid ones, but other various configurations may be adopted. Moreover, the present invention may be provided as a method or technique for executing pieces of processing relevant to the present invention, as a program for implementing the method or technique, or a recording medium in which the program is recorded. Moreover, the present invention may be provided as any type of system or equipment.

Moreover, the field to which the present invention is applied is not necessarily limited to the aforesaid one. The present invention can be applied to various fields.

Moreover, various pieces of processing to be performed by the system or equipment relevant to the present invention may be controlled when a processor runs a control program, which is stored in a read-only memory (ROM), in a hardware resource including the processor and memory. Moreover, pieces of functional means for executing the pieces of processing may be realized as independent hardware circuits.

Moreover, the present invention can recognize the control program as a recording medium in which the control program is stored to be readable by a computer, such as, a floppy disk (registered mark) or a compact disk (CD)-ROM, or the program (itself). When the control program is loaded from the recording medium to the computer and run by the processor, the pieces of processing relevant to the present invention can be carried out.

What is claimed is:

1. A radiocommunication system that allocates communication resource regions which are used for communication with equipment of a communicating party, comprising:
an inherent information acquisition means that acquires information inherent to each piece of equipment of a communicating party;
a number-of-resources information acquisition means that acquires information which specifies the number of communication resource regions to be reserved for communication with the equipment of the communicating party;
an association memory means that stores information, which is inherent to each piece of equipment of a communicating party and is acquired by the inherent information acquisition means, and information, which specifies the number of communication resource regions to be reserved for communication with the equipment of the communicating party and is acquired by the number-of-resources information acquisition means, in association with each other; and
a scheduling means that, for communication with equipment of a communicating party whose association is found to be stored on the basis of the contents of storage in the association memory means, reserves the number of communication resource regions associated with the equipment of the communicating party, and allocates communication resource regions to be used for communication with the equipment of the communicating party.
